(19) United States
(12) Patent Application Publication
(10) Pub. No.: US 2014/0060507 A1
(43) Pub. Date: Mar. 6, 2014

(54) ENGINE AND ENGINE-DRIVEN WORKING MACHINE

(71) Applicant: HITACHI KOKI CO., LTD., Tokyo (JP)

(72) Inventors: Tatsuya HAGAWA, Hitachinaka (JP); Shigetoshi ISHIDA, Hitachinaka (JP)

(73) Assignee: HITACHI KOKI CO., LTD., Tokyo (JP)

(21) Appl. No.: 14/013,406

(22) Filed: Aug. 29, 2013

(30) Foreign Application Priority Data
Aug. 30, 2012 (JP) 2012-190639

(51) Int. Cl. F02B 25/02

(52) U.S. Cl. CPC F02B 25/02
USPC 123/73 PP

(57) ABSTRACT

An engine and an engine-driven working machine which enable blow-though prevention of an uncombusted air-fuel mixture and control of the number of times of combustion, stabilize operation during idling, and ensure output and acceleration performance during working are provided. A two-cycle engine having: a piston; a crankcase in which scavenging passages are formed; and a cylinder in which scavenging ports communicated with the scavenging passages and an exhaust port for discharging a combustion gas are formed. In the two-cycle engine, at least two or more systems of the scavenging passages having mutually different opening/closing systems are formed in the crankcase.

### CROSS-REFERENCE TO RELATED APPLICATION

The present application claims priority from Japanese Patent Application No. 2012-190639 filed on Aug. 30, 2012, the content of which is hereby incorporated by reference into this application.

### TECHNICAL FIELD OF THE INVENTION

The present invention relates to scavenging passages of a two-cycle internal-combustion engine and opening/closing structures thereof and relates to an engine and an engine-driven working machine that reduce an exhaust-gas discharged volume, stabilize operation during idling, and ensure output and acceleration performance during working.

### BACKGROUND OF THE INVENTION

As disclosed in Japanese Patent Application Laid-Open Publication No. 62-3121 (Patent Document 1), small engines, particularly, two-cycle engines are widely used as power sources in small working machines such as mowing machines and chainsaws. The two-cycle engine is capable of obtaining large output with a small size and a light weight and enables a long period of time of working when supplied with fuel. Herein, a scavenging passage of a conventional two-cycle engine and an opening/closing structure thereof will be explained with reference to FIGS. 6 and 7. FIGS. 6 and 7 are vertical cross-sectional views showing internal structures of a two-cycle internal-combustion engine of conventional technique, FIG. 6 shows a state in which a piston is at an top dead center, and FIG. 7 shows a state in which the piston is at a bottom dead center. In the engine 101, a cylinder 103, which reciprocatably retains a piston 7, is attached to a crankcase 102. An intake port 104, an exhaust port 106, and combustion-chamber-side scavenging ports 105a and 105b are formed in a lateral wall of the cylinder 103. An air-fuel mixture in a cylinder combustion chamber 118 is compressed by upward motion of the piston 7, the intake port 104 is opened at the same time as that, and an air-fuel mixture for next combustion (hereinafter, referred to as an uncombusted air-fuel mixture) is taken into a crank chamber 110. At this point, the exhaust port 106 and the combustion-chamber-side scavenging ports 105a and 105b are closed by a lateral wall of the piston 7. When the air-fuel mixture compressed at the top dead center is combusted, downward motion of the piston 7 is started; and, after the intake port 104 is closed, opening of the exhaust port 106 and the combustion-chamber-side scavenging ports 105a and 105b is started. As a result of the downward motion of the piston 7, the uncombusted air-fuel mixture flows into the cylinder combustion chamber 118 via a scavenging passage 112 provided in the crank chamber 110, and the combusted air-fuel mixture is discharged from the exhaust port 106 in a manner that the combusted air-fuel mixture is pushed out by the uncombusted air-fuel mixture. Replacement of the air-fuel mixture is carried out in this manner; and, after passing through the bottom dead center shown by FIG. 7, the piston 7 starts upward motion again, and the intake port 104 is opened after the exhaust port 106 and the combustion-chamber-side scavenging ports 105a and 105b are closed. The two-cycle internal-combustion engine is operated by repeating the above-described steps. The two-cycle internal-combustion engine has a problem that blow-though of the uncombusted air-fuel mixture occurs since there is a period in which the exhaust port 106 and the scavenging passage 112 are opened at the same time due to the structure thereof.

As a technique which prevents blow-though of the uncombusted air-fuel mixture in the two-cycle internal-combustion engine, there are techniques which are to solve this problem by controlling the opening/closing timing of the scavenging passage and delaying the connecting timing of the scavenging passage with respect to the connecting timing of the exhaust port other than a stratified scavenging method, in-cylinder fuel injection, etc. One of them is a method in which a crank-chamber-side scavenging port is opened/closed by a counterweight formed at a crankshaft as shown in Patent Document 1. This method employs a structure in which the crank-chamber-side scavenging port, which is always open in a normal configuration, is connected to the scavenging passage only for a certain period, thereby opening/closing the crank-chamber-side scavenging port by the counterweight per se, which carries out rotary motion. The opening/closing timing of the scavenging passage can be changed by changing the shape of the counterweight. Another one is a method in which a valve is provided at the combustion-chamber-side scavenging port as shown in Japanese Patent Application Laid-Open Publication No. 5-222938 (Patent Document 2). More specifically, this is a method which changes the opened degree of the combustion-chamber-side scavenging port opened/closed by the piston lateral wall by controlling the opened degree of the valve by an actuator to enable control of the connecting timing of the scavenging passage.

### SUMMARY OF THE INVENTION

Regarding the two methods of Patent Documents 1 and 2, the former one has a problem that the scavenging volume cannot be optionally selected depending on the revolution speed of the engine, and the latter one has a defect that the mechanism thereof is large and complex. In addition to that, in the technique of Patent Document 2, in an idling state, an engine performs intermittent combustion; therefore, there are problems that the blow-though volume of the uncombusted air-fuel mixture is particularly large and that operation is not stable with large vibrations. Thus, the operation state is strongly required to be improved by reducing the exhaust-gas discharged volume during idling.

The present invention has been made in view of the above-explained background, and an object thereof is to provide an engine and an engine-driven working machine which enable prevention of the blow-though of the uncombusted air-fuel mixture and control of the number of times of combustion and ensure output and acceleration performance in working by stabilizing operation during idling.

Typical characteristics of the invention disclosed in the present application will be explained as below.

According to one of the characteristics of the present invention, a two-cycle engine has: a piston; a crankcase in which scavenging passages are formed; and a cylinder in which scavenging ports communicated with the scavenging passages and an exhaust port for discharging a combustion gas are formed. In the two-cycle engine, at least two or more systems of the scavenging passages having mutually different opening/closing systems are formed in the crankcase.

According to the present invention, the two or more systems of the scavenging passages having mutually different opening/closing systems are formed in the crankcase. Therefore, the blow-though of the uncombusted air-fuel mixture can be reduced as well as ensuring the output and acceleration performance during working by the engine.

The above and other preferred aims and novel characteristics of the present invention will be apparent from the description of the present specification and the accompanying drawings.

### BRIEF DESCRIPTIONS OF THE DRAWINGS

FIG. 1 is a vertical cross-sectional view showing an internal structure of an engine according to an embodiment of the present invention;

FIG. 2 is a schematic diagram showing an arrangement of scavenging passages in a crankcase of the engine according to the embodiment of the present invention;

FIG. 3 is a diagram showing port timing of the engine according to the embodiment of the present invention;

FIG. 4 is a diagram showing output curves explaining the relation between the revolution speed and output of the engine according to the embodiment of the present invention;

FIG. 5A is a diagram showing the relations between the revolution speed of the engine and opening/closing control of an electromagnetic valve according to the embodiment of the present invention, showing the relation between the engine revolution speed and output;

FIG. 5B a diagram showing the relations between the revolution speed of the engine and opening/closing control of the electromagnetic valve according to the embodiment of the present invention, showing the relation between the engine revolution speed and the opened degree of a second scavenging port;

FIG. 6 is a vertical cross-sectional view showing an internal structure of a two-cycle internal-combustion engine of conventional technique, showing a state in which a piston has been moved upward; and

FIG. 7 is a vertical cross-sectional view showing an internal structure of the two-cycle internal-combustion engine of the conventional technique, showing a state in which the piston has been moved downward.

### DESCRIPTIONS OF THE PREFERRED EMBODIMENTS

### First Embodiment

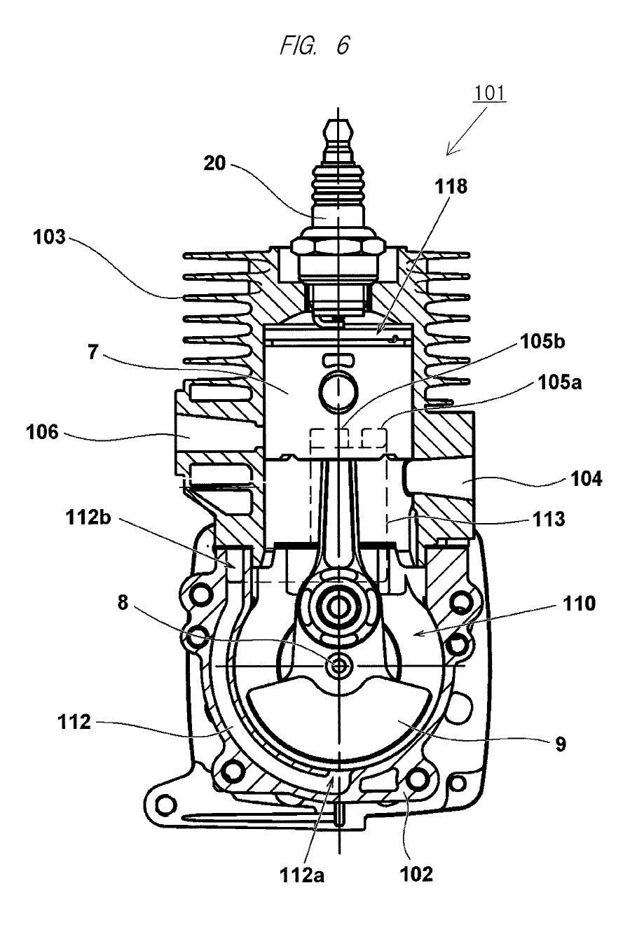

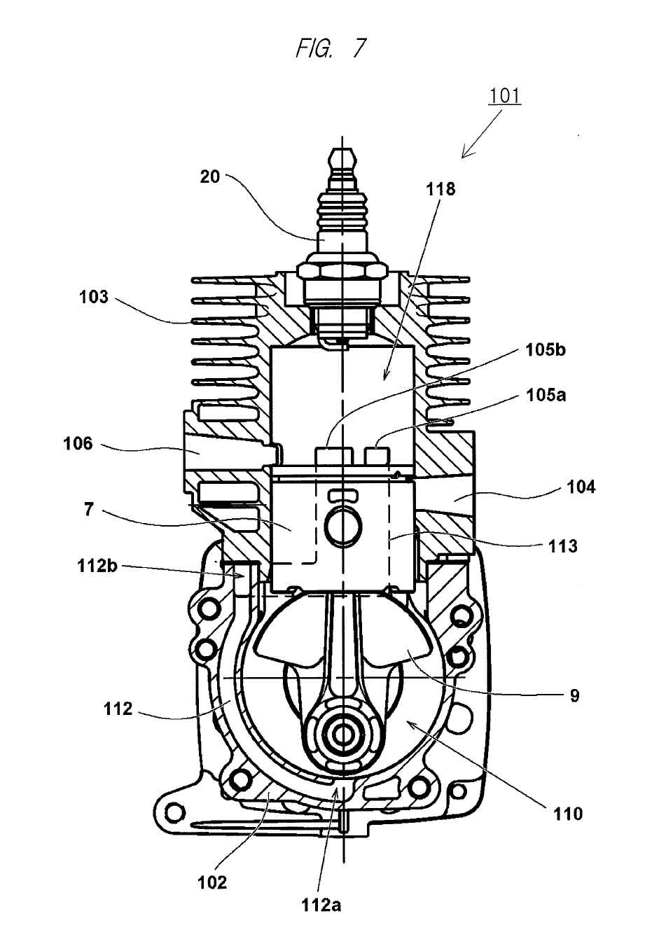

Hereinafter, embodiments of the present invention will be explained based on the drawings. Note that, in the drawings described below, the same parts as those of the conventional example shown in FIGS. 6 and 7 will be denoted by the same symbols, and repetitive descriptions will be omitted. In the present specification, front/rear, left/right, and top/bottom directions will be explained as the directions indicated in the drawings.

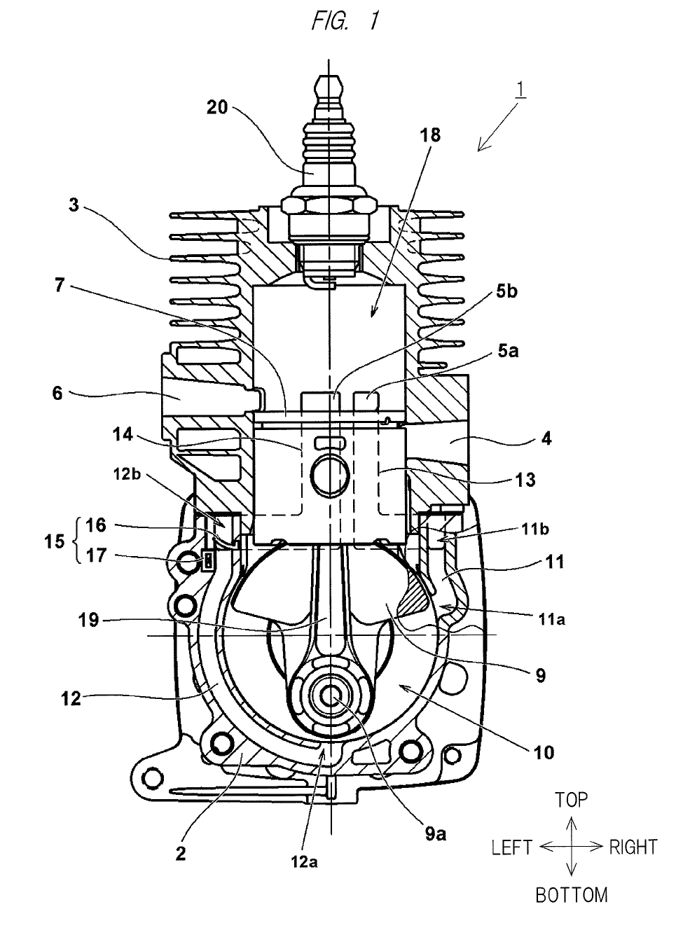

FIG. 1 is a vertical cross-sectional view showing an internal structure of an engine according to the embodiment of the present invention. A main point of the present embodiment that is different from the engine 101 of the conventional example shown in FIGS. 6 and 7 is a point that a crankcase 2 is equipped with two systems of scavenging passages (first scavenging passage 11, second scavenging passage 12). Also, another main point of the present embodiment that is different from the engine 101 of the conventional example shown in FIGS. 6 and 7 is a point that independent scavenging passages 13 and 14 are formed in a cylinder 3, the first scavenging passage 11 and a combustion-chamber-side scavenging port (scavenging port) 5a are communicated with each other via the scavenging passage 13, and the second scavenging passage 12 and a combustion-chamber-side scavenging port (scavenging port) 5b are communicated with each other via the scavenging passage 14. The engine 1 is a two-cycle-type internal combustion engine, and a crankshaft 8 provided with a counterweight 9 is rotatably attached to the crankcase 2. In the crankcase 2, the first scavenging passage 11 of which opening/closing is controlled by a counterweight system and the second scavenging passage 12 which can be forcibly closed by using an electromagnetic valve 15 are formed. Thus, in the crankcase 2, the two scavenging passages 11 and 12 having mutually different opening/closing systems are formed. As the configuration of the cylinder 3 side, the shapes and the formed positions of the combustion-chamber-side scavenging ports 5a and 5b are the same as those of the conventional example; however, as shown by dotted lines in FIG. 1, the first scavenging passage 11 is connected to the combustion-chamber-side scavenging port 5a via the scavenging passage 13, and the second scavenging passage 12 is connected to the combustion-chamber-side scavenging port 5b via the scavenging passage 14. As a method of forming the scavenging passages 13 and 14, there is a method in which a cylindrical sleeve is inserted to the inner side of the cylinder 3 after forming groove-like parts on the inner side of the cylinder 3. Also, the scavenging passages 13 and 14 can be formed in the cylinder 3 by another optional method.

The crank-chamber-side scavenging port (scavenging inlet) 11a continued to the first scavenging passage 11 of the counterweight system is provided in the crankcase 2 so as to face the radial-direction outer side of an outer peripheral surface of the counterweight 9. More specifically, the first scavenging passage 11 has a structure that the crank-chamber-side scavenging port 11a is practically opened/closed by the rotating counterweight 9 itself. The position of the crank-chamber-side scavenging port 11a is disposed in consideration of the opening timing and the closing timing of the combustion-chamber-side scavenging port 5a. In FIG. 1, the crank-chamber-side scavenging port 11a is disposed at apart which is slightly above the position of the crankshaft of a crank chamber 10 and is close to the cylinder 3. A cylinder-side scavenging outlet 11b of the first scavenging passage 11 is connected to the scavenging passage 13, which is formed in the cylinder 3, and the scavenging passage 13 is connected to the combustion-chamber-side scavenging port 5a. The scavenging timing using the first scavenging passage 11 is adjusted by adjusting the shape of the counterweight 9 (for example, the opening angle of a sector part) upon designing of the counterweight 9 or by moving the position of the crank-chamber-side scavenging port 11a in a circumferential direction upon designing of the crankcase 2. In the present embodiment, the position of the crank-chamber-side scavenging port 11a is set so as to delay the connecting timing of the first scavenging passage 11 of the counterweight system with respect to the opening timing of the exhaust port 6, which discharges a combustion gas.

In the present embodiment, furthermore, the crankcase 2 is provided with the second scavenging passage 12, and the electromagnetic valve 15 is provided in the second scavenging passage 12. The electromagnetic valve 15 is only required to be a valve mechanism which is capable of controlling an opening operation and/or a closing operation of the passage by supplying electric power from outside. The electromagnetic valve 15 of the present embodiment includes a reed valve 16, which can be forcibly closed by an electromagnet 17, and the electromagnetic valve 15 is disposed in the vicinity of a joined part between the crankcase 2 and a cylinder 3 of the crankcase 2. It is important that the reed valve 16 be formed of a magnetic substance in order to attract it to the electromagnet 17 and, for example, is formed of an iron-based thin plate. A crank-chamber-side scavenging port (scavenging inlet) 12a of the second scavenging passage 12 is provided in the vicinity of the center of a bottommost part of the crank chamber. In the present embodiment, the crankcase 2 is configured to be dividable into two in a left/right direction (in other words, the axial direction of the crankshaft), and the first scavenging passage 11 and the second scavenging passage 12 are formed by forming grooves on dividing faces of the crankcase 2. A cylinder-side scavenging outlet 12b of the second scavenging passage 12 is disposed to be adjacent to the electromagnetic valve 15 and is connected to the scavenging passage 14 formed in the cylinder 3.

The cylinder-side scavenging outlet 12b also functions as movable space of the reed valve 16. Therefore, the inner diameter of the cylinder-side scavenging outlet 12b is wider than the inner diameter of the second scavenging passage 12 in a part closer to the crank-chamber-side scavenging port 12a. In this manner, the cylinder-side scavenging outlet 12b has a stepped shape, and the reed valve 16 is disposed so that the vicinity of an outer peripheral edge of the reed valve 16 is in contact with the stepped part of the cylinder-side scavenging outlet 12b. As shown in FIG. 1, when the engine is not being operated, the reed valve 16 is opened and enables inflow of the air-fuel mixture from the crank chamber 10 to a cylinder combustion chamber 18. Note that, the reed valve 16 has a shape that is opened from the stepped part toward the cylinder 3 side; therefore, if there is blowback from the cylinder combustion chamber 18 side, the reed valve 16 is closed by the pressure of the blowback, and the blowback can be effectively prevented from reaching the crank chamber 10. When the piston 7 is moved downward (moved from the top dead center side to the bottom dead center side), the pressure in the crank chamber 10 side is increased; therefore, the air-fuel mixture flows into the cylinder combustion chamber 18 side via the first scavenging passage 11 and the second scavenging passage 12, and, in this process, the reed valve 16 is further opened by the flow (scavenging) of the air-fuel mixture. The above described operation is an operation in a state in which the reed valve 16 is not electrically controlled. When magnetic force is generated by supplying electricity to the electromagnet 17, the reed valve 16 can be attracted to the electromagnet 17 side, and the reed valve 16 can be maintained in a closed state. The present embodiment is configured to shut off the flow of the uncombusted air-fuel mixture from the second scavenging passage 12 to the cylinder combustion chamber 18 side and limit the scavenging volume to the cylinder combustion chamber 18 side by forcibly closing the reed valve 16 at optional timing.

The electromagnetic valve 15 is provided in the vicinity of the cylinder-side scavenging outlet 12b, in other words, in the vicinity of the cylinder-3 joined part of the crankcase 2. The electromagnetic valve 15 may be provided in the cylinder 3 side; however, since it is not thermally preferred, the electromagnetic valve 15 is preferred to be provided in the crankcase 2 side. A reason why the electromagnetic valve 15 is disposed in the vicinity of the cylinder-3 joined part of the crankcase 2 is that a depression for the space for housing the electromagnetic valve 15 can be easily mechanically processed. Although not shown in FIG. 1, lead wires for supplying electricity to the electromagnet 17 are connected from the outside of the engine 1 to the electromagnet 17. The electricity supply to the electromagnet 17 via the lead wires is controlled by an unshown control device for the electromagnetic valve, and the control device carries out opening/closing control of the reed valve 16 depending on the revolution speed of the engine 1.

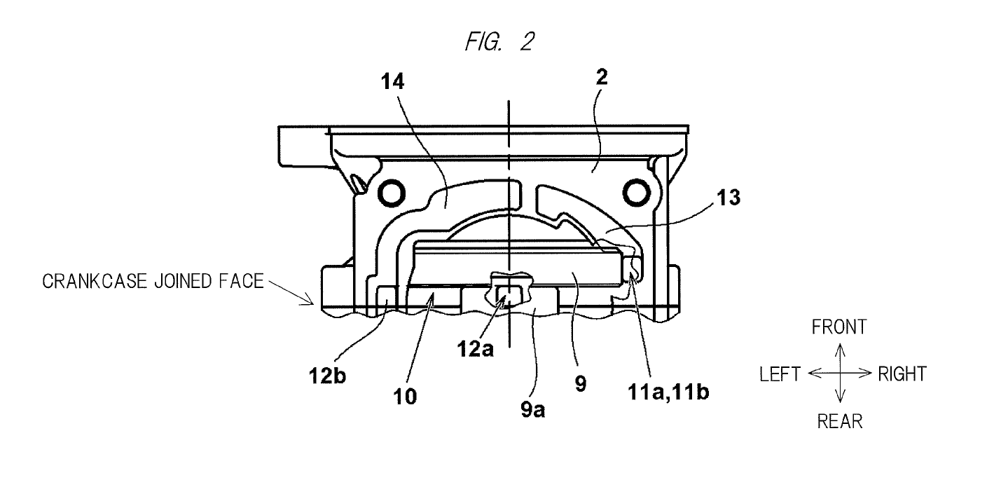

Next, the formed positions of the first scavenging passage 11 and the second scavenging passage 12 in the crankcase 2 will be explained by using FIG. 2. FIG. 2 is a schematic diagram for showing the arrangement of the scavenging passages in the crankcase of the engine according to the present embodiment. In the crank chamber 10, the counterweight 9 and a crank pin 9a connected thereto (see FIG. 1) are disposed. The crank pin 9a is disposed so as to penetrate through a ring part of a con rod 19. Herein, the crank-chamber-side scavenging port 11a is provided at a position opposed to an arc-shaped outer peripheral face (moving trajectory face in a case of revolution) of the counterweight 9. As shown in FIG. 2, the axial-direction position (front-rear position) of the crank-chamber-side scavenging port 11a is positioned within the range of the axial-direction width (front-rear direction width) of the counterweight 9. On the other hand, the crank-chamber-side scavenging port 12a of the second scavenging passage 12 is disposed to be displaced from the outer peripheral side of the moving range of the crank pin 9a and is configured so that the crank-chamber-side scavenging port 12a is not opened/closed by the counterweight 9. Therefore, the scavenging period of the second scavenging passage 12 can be configured to be longer than the scavenging period of the first scavenging passage 11.

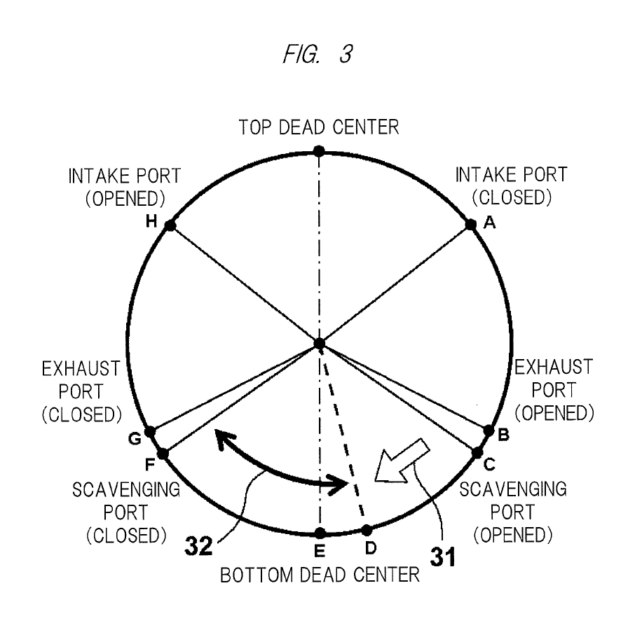

FIG. 3 is a diagram showing port timing of the engine according to the embodiment of the present invention. In the present embodiment, scavenging is carried out by using both of the first scavenging passage 11 and the second scavenging passage 12. When the piston 7 is moved from the top dead center to the bottom dead center, an intake port 4 is closed at a revolution angle A of the crankshaft 8 because of downward movement of the piston 7. Thereafter, when the piston 7 is further moved downward, an exhaust port 6 is opened at a revolution angle B. After the exhaust port 6 is opened, both of the combustion-chamber-side scavenging ports 5a and 5b are opened at a revolution angle C. At this point, the air-fuel mixture in the crank chamber 10 flows from the second scavenging passage 12 to the cylinder combustion chamber 18 via the opened electromagnetic valve 15. On the other hand, regarding the first scavenging passage 11, the crank-chamber-side scavenging port 11a of the first scavenging passage 11 is not opened until it reaches a revolution angle D. Therefore, during the period from the revolution angles C to D, the air-fuel mixture in the crank chamber 10 does not flow from the combustion-chamber-side scavenging port 5a side into the cylinder combustion chamber 18. When it reaches the revolution angle D, the crank-chamber-side scavenging port 11a is opened by the revolution position of the counterweight 9, and the air-fuel mixture in the crank chamber 10 therefore flows also from the combustion-chamber-side scavenging port 5a side into the cylinder combustion chamber 18. Note that, since the position of the revolution angle D is determined depending on the relative positional relation between the counterweight 9 and the crank-chamber-side scavenging port 11a, the range of an arrow 32 in FIG. 3 can be optionally set upon designing of the crankcase 2.

When the piston 7 starts upward movement again over the bottom dead center E, the combustion-chamber-side scavenging ports 5a and 5b are closed at a revolution angle F, and the exhaust port 6 is then closed at a revolution angle G. When the piston 7 is further moved upward toward the top dead center, the intake port 4 is opened at a revolution angle H by a skirt part of the piston 7, and the uncombusted air-fuel mixture is then ignited by a spark plug 20.

In this manner, in the present embodiment, the scavenging period of the first scavenging passage 11 is from the revolution angle D to the revolution angle F (the scavenging period=the revolution angle F−the revolution angle D), and the scavenging period of the second scavenging passage 12 is from the revolution angle C to the revolution angle F (the scavenging period=the revolution angle F−the revolution angle C). Note that the scavenging period is a period from start of the flow of the uncombusted air-fuel mixture from the crank chamber 10 to the cylinder combustion chamber 18 because of start of conduction of the scavenging passage until the flow is shut off. This scavenging period can be represented by the revolution angles of the crankshaft 8. In the above described explanation, the scavenging period of the second scavenging passage 12 has been explained to be from the revolution angle C to the revolution angle F; however, this scavenging period is a scavenging period in a state in which the electromagnetic valve 15 is open, in other words, in a state in which the reed valve 16 is not electrically controlled. In this manner, although the scavenging period of the second scavenging passage 12 side is longer than the first scavenging passage 11, the second scavenging passage 12 can be opened/closed by the electromagnetic valve 15; therefore, the scavenging period can be adjusted by opening/closing the reed valve 16 at optional timing.

When working such as mowing, branch cutting, or tilling is to be carried out by driving unshown working equipment by using the engine 1, the reed valve 16 is normally configured to be maintained in an open state (or to be openable/closable by a pressure change of the air-fuel mixture) by not supplying electricity to the electromagnetic valve 15. However, in a case of idling, when the engine is overdriven, or when the revolution speed of the engine is desired to be reduced for some reason, the scavenging volume is limited by closing the second scavenging passage 12, which is one of the two systems of the scavenging passages. This limitation of the scavenging volume can be carried out only by supplying electricity to the electromagnet 17 of the electromagnetic valve 15. When electricity is supplied to the electromagnet 17, the inflow of the air-fuel mixture into the cylinder combustion chamber 18 via the second scavenging passage 12 is stopped; therefore, only the scavenging by the first scavenging passage 11 remains, and the scavenging volume is limited. This state has an effect equivalent to an act of delaying the starting timing of scavenging into the cylinder combustion chamber 18, which has originally been at the revolution angle C, to the revolution angle D as shown by an arrow 31 of FIG. 3. When the electromagnetic valve 15 is used in this manner, the opening timing viewed as the whole scavenging ports can be delayed from the revolution angle (opening angle) C to the revolution angle (opening angle) D, and a harmful-exhaust-gas discharged volume can be reduced by reducing the blow-though volume of the uncombusted air-fuel mixture.

The present embodiment is configured to employ the electromagnet 17 as an electrically controllable valve (the electromagnetic valve 15) so as to drive the reed valve 16. However, the configuration of the electromagnetic valve 15 is not limited thereto, and another optional valve mechanism that can be electrically controlled to be opened/closed such as a system that controls the valve by using an actuator or a system that closes a passage by using a solenoid or the like may be used. In the system using the electromagnet 17 and the reed valve 16 of the present embodiment, the structure is simple, and the entirety can be downsized compared with the other valve mechanisms. Note that the first scavenging passage 11 and the second scavenging passage 12 are configured so that the scavenging passages 13 and 14 to the combustion-chamber-side scavenging port 5a and the combustion-chamber-side scavenging port 5b are independent, but may be configured to be integrated to intermediate parts of the scavenging passages 13 and 14.

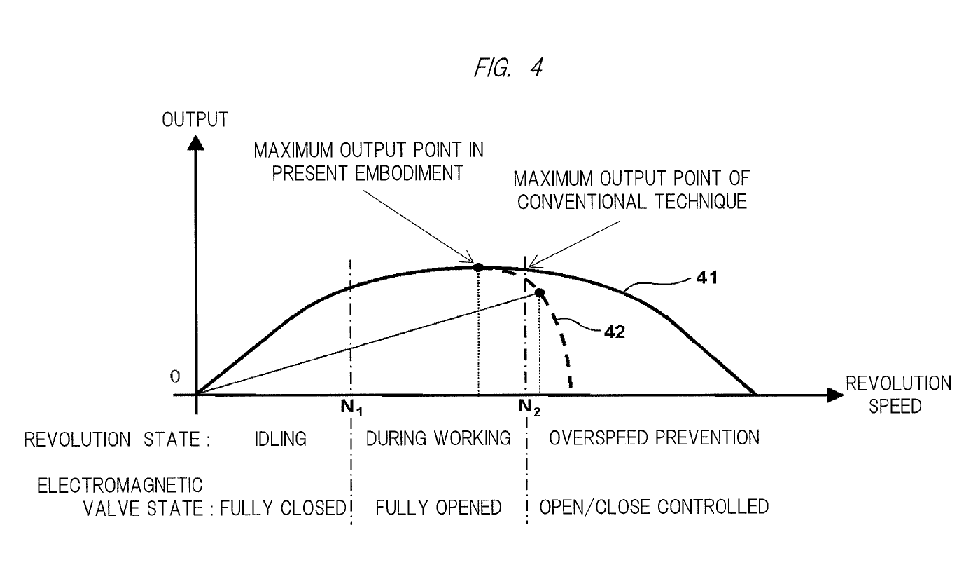

FIG. 4 shows output curves showing the relation between the revolution speed and output of the engine according to the embodiment of the present invention. According to the present configuration, blow-though of the uncombusted air-fuel mixture can be steadily reduced by the effect of the first scavenging passage 11 of the counterweight system. In addition to that, when the scavenging volume is reduced by fully closing the reed valve 16 of the second scavenging passage 12 during idling revolution, intermittent combustion can be prevented; as a result, the volume of the uncombusted air-fuel mixture can be reduced, and the operation state such as vibrations can be stabilized. Moreover, regarding the revolution speed of the engine used in working, etc., the reed valve 16 is fully opened to increase the scavenging volume and supply the air-fuel mixture of the volume required for combustion; as a result, the output and acceleration performance of the engine are ensured. Furthermore, when the reed valve 16 is closed depending on increase in the revolution speed during overspeed of the engine (revolution speed of N₂ or higher), the engine revolution speed, output, and the discharged volume of the uncombusted air-fuel mixture can be reduced. The tendency in the output change in the overspeed region can be adjusted by the control in this process from an output 41 of the conventional example shown in FIGS. 6 and 7 to an output 42 of the present embodiment. Thus, the revolution speed at a maximum output, in other words, the revolution speed at the point most distant from the original point of the output curve and the value of the exhaust-gas discharged volume can be adjusted; therefore, exhaust gas regulations can be handled without excessively depending on catalysts, etc.

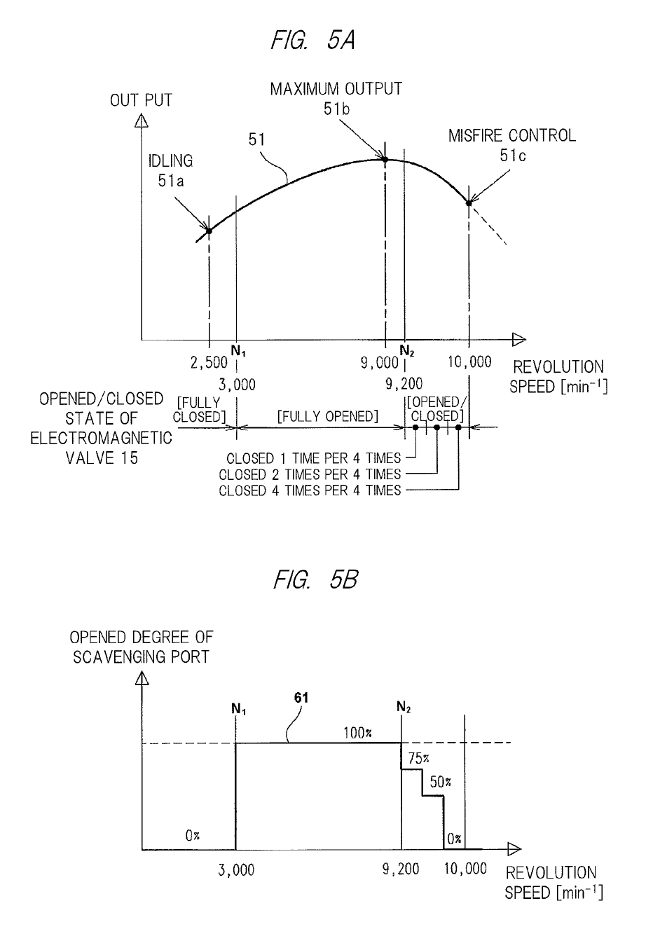

FIGS. 5A and 5B are diagrams showing the relations between the revolution speed of the engine and the opening/closing control of the electromagnetic valve according to the embodiment of the present invention. Both of FIGS. 5A and 5B show the engine revolution speed (min⁻¹) by the horizontal axis, the vertical axis of FIG. 5A shows the output (unit: kw) of the engine 1, and the vertical axis of FIG. 5B shows the opened degree of the scavenging port of the second scavenging passage 12. Note that (min⁻¹) shown as the unit of the engine revolution speed means rpm (revolutions per minute). In the present embodiment, an engine output 51 is gradually increased from idling 51a (about 2,500 min⁻¹) and achieves a maximum output 51b at about 9,000 min⁻¹. When the engine is rotated over the maximum output 51b, the engine output 51 is gradually reduced; however, in order to prevent overspeed, when the output exceeds 9,200 min⁻¹, control of reducing the scavenging volume to reduce the revolution speed of the engine is carried out by controlling the electromagnetic valve 15. If the revolution speed is not reduced even by the control, misfire control 51c of cutting off the high-voltage electric current, which is supplied to the spark plug 20, is used in combination at about 10,000 min⁻¹. Since the method of this misfire control is publicly known, the control herein is omitted.

The open/close state of the electromagnetic valve 15 is shown in the lower side of FIG. 5A. Until 3,000 min⁻¹, which is slightly higher than the revolution speed of idling, the electromagnetic valve 15 is maintained in a fully closed state, in other words, maintained in a state in which the reed valve 16 is forcibly closed by supplying electric power to the electromagnet 17. By virtue of this control, the scavenging volume can be appropriately maintained; therefore, occurrence of misfire during idling can be prevented, and idling stabilization and reduction in the exhaust-gas discharged volume can be achieved by every-time combustion. From the engine revolution speed of 3,000 to 9,200 min⁻¹, the electromagnetic valve 15 is caused to be in an opened state, in other words, the reed valve 16 is caused to be in a fully opened state without supplying electric power to the electromagnet 17, thereby ensuring output/acceleration performance in working. However, as the fully opened state, the reed valve 16 may be configured to be openable/closable by the pressure difference between the cylinder combustion chamber 18 and the crank chamber 10 so as to prevent blow-though. When the engine revolution speed exceeds 9,200 min⁻¹, the electromagnetic valve 15 is controlled so as to be gradually closed.

The opened degree of the electromagnetic valve 15 of the present embodiment can be controlled by closing some revolutions among a plurality of revolutions of the crankshaft 8, instead of analog control such as half-open or ¼-open of the opened/closed degree of the valve. FIG. 5B shows the state of the opened degree, wherein at 9,200 to 9,500 min⁻¹, an opened degree of 75% is obtained by closing the electromagnetic valve 15 only by a period corresponding to one revolution per four revolutions of the engine. At 9,500 to 9,750 min⁻¹, an opened degree of 50% is obtained by closing the electromagnetic valve 15 only by a period corresponding to two revolutions per four revolutions of the engine. At 9,750 to 10,000 min⁻¹, an opened degree of 0% is obtained by closing the electromagnetic valve 15 for a period corresponding to four revolutions per four revolutions of the engine, in other words, by fully closing it. When prevention of the excessive control of the engine 1 and misfire control are carried out by controlling the electromagnetic valve 15 in this manner, the exhaust-gas discharged volume can be reduced. The second scavenging passage 12 is subjected to open/close control by the opened degrees of 100% to 0%, while the opened degree of the crank-chamber-side scavenging port 11a of the first scavenging passage 11 is fixed; therefore, misfire of the engine 1 caused by full closure of the scavenging ports can be prevented, and the engine revolution speed and output can be stably adjusted without stopping the engine 1.

Hereinabove, the present invention has been explained based on the embodiment. However, the present invention is not limited to the above described embodiment, and various modifications can be made within a range not departing from the gist thereof. For example, in the above described embodiment, the electromagnetic valve is limited to the control of the opened or closed state; however, the scavenging volume of the second scavenging passage 12 may be configured to be adjustable by using an optional electric control valve capable of variably controlling the opened degree. Moreover, in the above described explanations, the two systems of the scavenging passages 11 and 12 are formed in the crankcase 2; however, the invention is not limited thereto, and three or more systems of scavenging passages may be formed in the crankcase 2. Moreover, the above described engine 1 can be used as a power source of working equipment provided in an engine-driven working machine such as a mowing machine or a chainsaw. When the engine-driven working machine is equipped with the engine 1, the working equipment for carrying out mowing, branch cutting, tilling, etc. is driven by the engine 1.

Hereinafter, the embodiments of the engine and the engine-driven working machines and effects obtained by the embodiments will be collectively described.

In an engine according to one of the embodiments, the two-cycle engine has: a crankcase in which scavenging passages are formed; and a cylinder in which scavenging ports communicated with the scavenging passages and an exhaust port for discharging a combustion gas are formed; wherein at least two or more systems of the scavenging passages having mutually different opening/closing systems are formed in the crankcase. In this manner, the at least two or more systems of the scavenging passages having the mutually different opening/closing systems are formed in the crankcase. Therefore, blow-though of the uncombusted air-fuel mixture can be reduced while ensuring the output and acceleration performance during working by the engine.

In the engine according to another one of the embodiments, at least one of the systems of the scavenging passages is provided with an electrically controllable valve. In this manner, the at least one of the systems of the scavenging passages is provided with the electrically controllable valve. Therefore, the scavenging volume can be optionally adjusted depending on the revolution speed of the engine.

In the engine of another one of the embodiments, at least one of the systems of the scavenging passages has a scavenging inlet that is opened/closed by utilizing revolution of a counterweight formed at a crankshaft. In this manner, the at least one of the systems of the scavenging passages has the scavenging inlet that is opened/closed by utilizing the revolution of the counterweight. Therefore, the scavenging period can be adjusted as the opening/closing system by rotary motion of the counterweight.

In the engine of another one of the embodiments, a scavenging inlet of the scavenging passage provided with the valve is provided in a crank chamber of the crankcase and at a position at which the scavenging inlet is not opened/closed depending on the position of the counterweight. In this manner, the scavenging inlet of the scavenging passage provided with the valve is provided at the position at which the scavenging inlet is not opened/closed depending on the position of the counterweight. Therefore, when the scavenging passage in the side not affected by the rotary motion of the counterweight is opened/closed by the valve, the two-cycle engine that enables prevention of blow-though of the uncombusted air-fuel mixture and control of the number of times of combustion and achieves reduction of an exhaust-gas discharged volume, operation stabilization during idling, and the output and acceleration performance during working can be achieved.

In the engine according to another one of the embodiments, the scavenging inlet of the scavenging passage provided with the valve is disposed in a vicinity of a center of a bottommost part of the crank chamber. In this manner, the scavenging inlet of the scavenging passage provided with the valve is disposed in the vicinity of the center of the bottommost part of the crank chamber. Therefore, the inlet of the scavenging passage that is always in an opened state without being affected by the revolution position of the counterweight can be achieved.

In the engine of another one of the embodiments, a scavenging period of the scavenging passage provided with the valve is longer than a scavenging period of the scavenging passage that is opened/closed by utilizing the revolution of the counterweight. More specifically, the engine can be designed so that the scavenging timing is adjusted by employing the opening/closing system using the rotary motion of the counterweight for one of them, and the other one employs the opening/closing system utilizing the electromagnetic valve so that the scavenging volume can be optionally adjusted depending on the engine revolution speed during actual operation. In this manner, the scavenging period of the scavenging passage provided with the valve is longer than the scavenging period of the scavenging passage that is opened/closed by utilizing the revolution of the counterweight. Therefore, the adjustment degree of the scavenging volume can be largely ensured by the valve.

In the engine of another one of the embodiments, a control device that carries out opening/closing control of the valve is provided; and the control device carries out the opening/closing control of the valve depending on a revolution speed of the engine. In this manner, the control device carries out the opening/closing control of the valve depending on the revolution speed of the engine. Therefore, overspeed of the engine can be limited.

In the engine of another one of the embodiments, the valve is a reed valve that can be closed by an electromagnet; and the control device closes the reed valve during idling revolution, closes the reed valve depending on the revolution speed of the engine during overspeed, and fully opens the reed valve at a revolution speed different from those of the idling revolution and the overspeed. In this manner, the control device closes the valve during the idling revolution; therefore, the exhaust-gas discharged volume during idling can be reduced, and the idling operation can be stabilized. Moreover, during overspeed, the valve is closed depending on the engine revolution speed; and, at the revolution speed other than them, the valve is fully opened. Therefore, the output and acceleration during working can be ensured.

In the engine of another one of the embodiments, the reed valve is provided in the scavenging passage formed in the crankcase and in a vicinity of a part joined with the cylinder. In this manner, the reed valve is provided in the scavenging passage formed in the crankcase and in the vicinity of the part joined with the cylinder. Therefore, crank-case processing for ensuring the installation space of the electromagnetic valve can be carried out from the dividing faces, and cost increase caused by increase in the machine processing locations can be minimized.

In an engine-driven working machine of one of the embodiments, working equipment is driven by using the engine according to any one of claims 1 to 9. In this manner, the working equipment is driven by using the engine according to any one of claims 1 to 9 . Therefore, the engine-driven working machine that is excellent in an exhaust-gas characteristic, is capable of preventing overspeed of the engine, has a light weight, and is usable can be achieved.

What is claimed is:

1. A two-cycle engine comprising:
a piston;
a crankcase in which scavenging passages are formed; and
a cylinder in which scavenging ports communicated with the scavenging passages and an exhaust port for discharging a combustion gas are formed,
wherein at least two or more systems of the scavenging pas sages having mutually different opening/closing systems are formed in the crankcase.

2. The engine according to claim 1,
wherein at least one of the systems of the scavenging passages is provided with an electrically controllable valve.

3. The engine according to claim 2,
wherein at least one of the systems of the scavenging pas sages has a scavenging inlet that is opened and closed by utilizing revolution of a counterweight formed at a crankshaft.

4. The engine according to claim 3,
wherein a scavenging inlet of the scavenging passage provided with the valve is provided in a crank chamber of the crankcase and at a position at which the scavenging inlet is not opened and closed depending on the position of the counterweight.

5. The engine according to claim 4,
wherein the scavenging inlet of the scavenging passage provided with the valve is disposed in a vicinity of a center of a bottommost part of the crank chamber.

6. The engine according to claim 3,
wherein a scavenging period of the scavenging passage provided with the valve is longer than a scavenging period of the scavenging passage that is opened/closed by utilizing the revolution of the counterweight.

7. The engine according to claim 2, further comprising
a control device carrying out opening/closing control of the valve,
wherein the control device carries out the opening/closing control of the valve depending on a revolution speed of the engine .

8. The engine according to claim 7,
wherein the valve is a reed valve which can be closed by an electromagnet; and
the control device closes the reed valve during idling revolution, closes the reed valve depending on the revolution speed of the engine during overspeed, and fully opens the reed valve at a revolution speed different from those of the idling revolution and the overspeed.

9. The engine according to claim 8,
wherein the reed valve is provided in the scavenging passage formed in the crankcase and in a vicinity of a part joined with the cylinder.

10. An engine-driven working machine driving working equipment using the engine according to claim 1.
